(19) United States
(12) Patent Application Publication
(10) Pub. No.: US 2023/0418037 A1
(43) Pub. Date: Dec. 28, 2023

(54) IMAGE SCANNING APPARATUS AND METHOD

(71) Applicant: FFEI LIMITED, Waterbeach, Cambridge (GB)

(72) Inventor: Martin GOUCH, Hemel Hempstead (GB)

(73) Assignee: FFEI LIMITED, Waterbeach, Cambridge (GB)

(21) Appl. No.: 18/036,796

(22) PCT Filed: Nov. 12, 2021
(86) PCT No.: PCT/GB2021/052925

§ 371 Date: May 12, 2023

(30) Foreign Application Priority Data
Nov. 17, 2020 (GB) 2018046.9

(51) Int. Cl. G02B 21/00; G02B 21/18

(52) U.S. Cl. CPC G02B 21/0044; G02B 21/006; G02B 21/0068; G02B 21/18

(57) ABSTRACT

Image scanning apparatus comprises a plurality of imaging sensors for generating image data; a focusing system and a scanning system. The focusing system defines an optical axis and directs light received from a target on to the imaging sensors. Each imaging sensor is positioned with respect to the focusing system such that, the light directed to the imaging sensor has an optical focus level with respect to the target which is different from each other imaging sensor, and the light is received from a position on the target with respect to the optical axis which is different from the respective position for each other imaging sensor. The focusing system comprises a optical path modifier so as to generate a first light path between the optical path modifier and at least one of the plurality of imaging sensors, and a second light path between the optical path modifier and at least one of the imaging sensors, wherein the first light path is different from the second light path. The scanning system is arranged in use to cause the target to be moved relative to the optical axis such that an image of the target may be generated using the image data from the plurality of image sensors. A method of using the apparatus is also disclosed.

### FIELD OF THE INVENTION

The present invention relates to image scanning apparatus, together with methods of using such apparatus.

### BACKGROUND TO THE INVENTION

Whole slide virtual microscope scanners are designed to scan the whole of a microscope slide, such as a pathology slide, in high magnification. With a high magnification a pixel width of the scanner image sensor may correspond to approximately 0.25 μm of linear dimension of a target sample mounted to the microscope slide. This combined with a high numerical aperture in the optical system, such as approximately 0.75, results in a low depth of field, such as approximately 1 μm. As the height of the surface of a typical pathology slide varies by more than 1 μm it is necessary to vary the focus of the scanner to maintain the tissue of the target in focus. There are several schemes which describe this focus control such as in our earlier patents U.S. Pat. Nos. 9,638,573, 7,485,834 and 9,116,035.

There are some tissue types, for example single cell or cytology, which have a larger range of focus than that available in a single image of 1 μm depth of focus. It is typical in these conditions to increase the apparent depth of focus of a virtual image by performing “Z stack” or volume scanning. With this technique the same area of the target on the slide is scanned but at different focus positions (“focus levels”). The image viewing application can then select which plane of focus is viewed. This Z stack scanning can be performed with a constant focus level for each stack such as is described with reference to FIG. 2 of our earlier patent U.S. Pat. No. 7,702,181 or with a variable focus which tracks the general focus such as is described with reference to FIG. 13 of U.S. Pat. No. 7,702,181.

There are a number of ways of performing this Z stack scanning as described in the prior art. These include the use of a tilted stage and a 2D sensor as described in US20090295963, or a tilted 2D sensor as described in U.S. Pat. No. 8,059,336 where each line on the 2D sensor is at a slightly different focus level and by obtaining data from specific regions of the 2D sensor or single lines of the sensor a Z stack can be constructed. Another method of performing Z stack scanning is to use a device such as a fibre array to produce different focus levels as is described in EP0834758.

Alternatively, it is possible to construct multiple sensors and use beam splitters to produce images at corresponding different foci, as is described in U.S. Pat. No. 6,839,469. The problem with using the multiple beam splitters is that each beam splitter reduces the amount of light for each sensor by a factor dependent upon the number of sensors.

In the light of the issues discussed above there is an ongoing need to improve the techniques used in image scanning so as to allow high quality images of tissue and other biological targets to be obtained rapidly despite the inherent surface topographies of such targets.

### SUMMARY OF THE INVENTION

In accordance with a first aspect of the present invention there is provided an image scanning apparatus comprising:

a plurality of imaging sensors for generating image data;

a focusing system defining an optical axis and adapted in use to direct light received from a target on to the plurality of imaging sensors

wherein each imaging sensor is positioned with respect to the focusing system such that, the light directed to the imaging sensor has an optical focus level with respect to the target which is different from each other imaging sensor, and the light is received from a position on the target with respect to the optical axis which is different from the respective position for each other imaging sensor;

wherein the focusing system comprises an optical path modifier adapted to generate a first light path between the optical path modifier and at least one of the plurality of imaging sensors, and a second light path between the optical path modifier and at least one of the imaging sensors, wherein the first light path is different from the second light path; and

a scanning system arranged in use to cause the target to be moved relative to the optical axis such that an image of the target may be generated using the image data from the plurality of image sensors.

The present invention therefore improves upon known techniques. By the use of multiple imaging sensors in “off axis” arrangements, it is possible to obtain images from different positions on the target at the same time whilst minimising any unwanted reduction in the intensity of the received light. This provides a more efficient use of the light received from the sample in comparison with on-axis only systems. The use of multiple imaging sensors advantageously allows for the acquisition of images at multiple focus levels at the same time. In each case the capability of images being acquired at the same time may include either acquisitions which are simultaneous or at least substantially so. Furthermore, the lack of reduction in the light intensity enables, in some examples, a beam splitter to be used as an optical path modifier so as to divert a proportion of the light in a way that allows images to be generated at still further focus levels due to the different dimensional length of the respective paths along which the light is transmitted. Thus, the optical path length of the first light path may be different from the optical path length of the second light path. This may be achieved by using path lengths that differ in physical dimension, or by the use of transmission media that have different refractive indices, or both. The optical path length for each light path is the sum of the products of the geometrical length of the light path and the respective refractive index of the respective optical medium for each different optical medium through which the light travels. The difference between the optical path lengths of the first and second light paths results in a non-zero optical difference between the light paths.

The combination of the specific position upon the target from which the light is received, and the specific path along which that light is transmitted, results in a focus level which is different from each other focus level. This allows multiple focus levels to be imaged in a way which allows for a “single pass” scan to be utilised with a large number of focus levels in the resulting Z stack image.

In most cases the light travels along its path between the target and the respective imaging sensor through various regions of either air or glass, the glass being embodied in lenses and other optical devices. Optically transparent polymer materials are examples of optically transmissive media which may alternatively be used instead of glass. In order to modify the path length using the refractive index of an optically transmissive medium, the apparatus may further comprise a retarding element placed in the one of the said first or second light paths, the retarding element having a refractive index arranged to modify the optical path length of the said optical path in which it is placed. Typically the refractive index of the retarding element is in excess of 1.5 and the thickness of the material may be in excess of 30 mm. For example to obtain a 50 mm shift in focus with glass of refractive index 1.5 requires a thickness of 150 mm whilst to produce the same 50 mm shift with Flint Glass of refractive index 1.9 only requires a thickness of 105 mm. If Cubic Zirconia is used with a refractive index of 2.15 then the required thickness is less, at 94 mm.

A single beam splitter may be used as the optical path modifier to generate the first and second light paths, in which case different imaging sensors may be provided to receive the light which has been transmitted along the first light path, in comparison with that which has been transmitted along the second light path. As will be appreciated, imaging sensors are expensive devices and in some examples the optical path modifier is a first beam splitter and the apparatus further comprises a second beam splitter arrange to combine the first and second light paths back together spatially, such as arranging the beams downstream of the second beam splitter to be collinear. The use of two beam splitters provides the ability to arrange the imaging sensors to receive light from each of the first and second light paths. The beam splitters are typically arranged to provide 50% transmission and 50% reflection of incident light although other ratios could be used if required. The beam splitters may be non-polarising although there are some advantages in using polarising beam splitters so as to improve the intensity of light received upon recombining the two light paths prior to detection at the imaging sensors.

The apparatus further comprises a switching mechanism configured to be switched a first mode in which the light is transmitted along the respective light path and a second mode in which the light is not transmitted along the respective light path. In the first mode the light may be transmitted along the first optical path and not the second optical path, and in the second mode the light may be transmitted along second optical path and not the first optical path.

The apparatus may further comprise:

a first optical shutter in the first light path; and

a second optical shutter in the second light path,

wherein each of the first and second optical shutters is adapted to be switched between a first mode in which the light is transmitted along the respective light path and a second mode in which the light is not transmitted along the respective light path. Thus, the first optical shutter and the second optical shutter may form part of the switching mechanism. The first and second light paths may also comprise further optical devices to modify the optical path length or otherwise manipulate the light. For example a part of the second light path between the first and second beam splitters may comprise the second optical shutter and at least one mirror.

The optical shutters may take a number of different forms. For example an optical shutter may be simply a mechanical shutter. It may be a moveable mirror coupled with a mechanical actuator so as to transmit the light either along the respective light path towards the one or more imaging sensors, or away in another direction so that the light does not reach the sensors. This may be achieved effectively in practice using a micro-electromechanical system (MEMs) mirror. Another example is the use of a rotatable disc such as one with slots or apertures distributed about its central axis, with the disc being rotated about the central axis.

Whilst one might consider that a single device could be used to switch between the two light paths, in practice their switching speed is not fast enough to match the line time of modern sensors (which are in excess of 30 KHz). This would preclude their use from many applications. In contrast a Pockles cell (see below) for example can switch as fast as 1 MHz and does not need to be sinusoidal. This leaves most of the time in the none switching state so the sensor can be used for imaging and therefore gives most of the time for integrating.

Typically in most applications the light is white light or broad-spectrum in nature. This also precludes the use of monochromatic steering or switching elements such as acoustic modulators.

Optical devices which rely on the application of electric fields to materials provide particular benefits due to their high switching speeds. Examples of these include Pockels cells, photo-elastic modulators and liquid crystal shutters. As will be understood, these may inherently cause a change in the polarisation state of the light.

As is mentioned above, the polarisation of the light may be used to effect the selective transmission of the light along the first light path and the second light path. This is particularly advantageous in arrangements where the imaging sensors are arranged to receive light from each of the first and the second light paths and each optical path modifier may be a polarising beam splitter. Here, the apparatus may further comprise a polarising optical shutter adapted to be switched between a first mode in which the light is transmitted along the first optical path and not the second optical path, and a second mode in which the light is transmitted along second optical path and not the first optical path. The polarising optical shutter may form part of the switching mechanism. In perhaps its most fundamental form a mechanically rotatable analyser could perform this function although the analyser would only be useable for around 10% of the time in this arrangement in conjunction with a strobing technique since otherwise, for the majority of the transmission time, the light would be in a mixture of the two extremum polarisation states rather than each useful extremum state. The polarising optical shutter may placed upstream of the first polarising beam splitter or downstream of the second polarising beam splitter. This enables a single optical shutter to be used rather than one for each of the two paths.

When the polarising optical shutter is upstream, the polarising optical shutter may comprise a polarising beam splitter, a first light source having light arranged to be transmitted through the polarising beam splitter in an illumination direction and a second light source having light arranged to be reflected by the polarising beam splitter in the illumination direction and wherein the light from the first light source travelling in the illumination direction is arranged to have a different polarisation plane than the light travelling in the illumination direction from the second light source.

A number of arrangements in which the optical path modifier is a beam splitter are described above. Other devices may be used. In some examples, the optical path modifier itself is provided as a rotating disc having a plurality of regions positioned about its axis, the regions being of two or more different optical thicknesses and arranged azimuthally, preferably according to an alternating pattern of thicknesses. The optical path modifier in this form, or in others, may therefore divide the beam temporally (rather than spatially), into an equivalent number of optical path lengths even though the light in each case geometrically traverses a common spatial path. The optical path modifier may comprise an optical shutter adapted to be switched between a first mode in which the light is transmitted along the first light path and a second mode in which the light is transmitted along the second light path. Thus, the switching mechanism may comprise an optical shutter and the switching mechanism may form part of the optical path modifier. In the case of a rotating disc the optical path modifier has this function integrally. The different material thicknesses of the regions can be synchronised by the rotation of the disc with the acquisition of the image data from the imaging sensors to as to produce two or more different focus levels for each sensor.

The apparatus finds particular benefit when the focusing system forms at least part of a microscope such as one in which high resolution images at high magnification can be taken across extensive regions of biological sample targets.

This is effected by the multiple focus levels at which imaging data is taken, together with the use of a scanning system. Using the apparatus the image is typically formed as a Z stack having four levels generated using either two or four imaging sensors, or having six levels generated using either three or six imaging sensors. Swathes of image data may be generated from the target without the need for repeated imaging of the same region of the target such that a “single pass” imaging methodology can be achieved.

The operation of the apparatus, and in particular the scanning system, imaging sensors and optical shutters may be effected using a suitable control system. Typically such as system will include a computer having an appropriate user interface and the capability of converting a Z stack image which may be subjected to image processing so as to produce an image which may be analysed by either a human or appropriate software. The software for performing such analysis functions may also be executed on the same computer.

In accordance with a second aspect of the invention we provide a method of image scanning using image scanning apparatus according to the first aspect when provided with the first and second beam splitter, together with the first and second optical shutters, the method comprising, operating the first optical shutter and the second optical shutter such that the first optical shutter is in the first mode when the second optical shutter is in the second mode and the first optical shutter is in the second mode when the second optical shutter is in the first mode, so as to selectively transmit the light along the first light path and the second light path.

In accordance with a third aspect of the invention we provide a method of image scanning using image scanning apparatus according to the first aspect when provided with the first and second polarising beam splitters, together with the polarising optical shutter, the method comprising, operating the polarising optical shutter so as to selectively transmit the light to the imaging sensors along the first light path and the second light path. Depending upon the arrangement of the apparatus, the light may be transmitted along each path but due to the mode of the polarising optical shutter, only light from one of these two paths is permitted to be incident upon the imaging sensors at any one time.

According to the second aspect, the first optical shutter and second optical shutter may be operated in their respective first and second modes, alternately, whilst the target is moved relative to the optical axis so as to generate image data at a plurality of focus levels. According to the third aspect, the polarising optical shutter may be operated in its respective first and second modes, alternately, whilst the target is moved relative to the optical axis so as to generate image data at a plurality of focus levels. The alternating of the first and second modes is preferably synchronised with the scanning system and the imaging sensors such that corresponding image information is obtain from specific positions on the target. For example the positions corresponding to the first optical path may be interleaved with those corresponding with the second optical path. The positions may also have spatial registration with respect to other positions on the target forming different swathes of the image.

Although a number of focus levels are provided by the apparatus and method, such as six levels or more, the apparatus may be operated during use such that the focus of a number, or preferably all, levels of focus may be modified during the scan so as to follow the topography of the target. In order to achieve this the image data for the different imaging sensors may be processed as part of the method so as to calculate focus merit values for the focus levels and the focus of the respective levels may be modified accordingly during the scan so as to apply an offset to the focus position of the levels.

### BRIEF DESCRIPTION OF THE DRAWINGS

Some examples of the present invention are now described with reference to the accompanying drawings, in which:

FIG. 1 is a schematic illustration of the main components of a virtual microscope according to all examples of the invention;

FIG. 2 shows a first example of the invention using a single beam splitter and six imaging sensors;

FIG. 3 shows a second example of the invention utilising a glass block to equalise the optical path lengths;

FIG. 4 is a flow diagram illustrating a method of using the apparatus according to the second to fifth examples;

FIG. 5 shows a third example of the invention with similar path lengths;

FIG. 6 shows a fourth example of the invention, similar to the third example and with different imaging sensor positions;

FIG. 7a shows a fifth example of the invention using two polarising beam splitters with three imaging sensors;

FIG. 7b shows a modified fifth example with two imaging sensors;

FIG. 8a shows a sixth example of the invention using a two mode optical shutter in an upstream location and with three imaging sensors;

FIG. 8b shows a modified sixth example with two imaging sensors;

FIG. 9 shows a seventh example of the invention using a two mode optical shutter in a downstream location;

FIG. 10 is a flow diagram illustrating a method of using the apparatus according to the sixth and seventh examples;

FIG. 11 shows an eighth example of the invention using a beam splitter and two optical sources as the optical shutter;

FIG. 12 shows the optical shutter arrangement of the eighth example;

FIG. 13 shows a ninth example of the invention using a rotating disc with modulated optical thickness as the beam splitter; and,

FIG. 14 shows an axial view of the disc of the ninth example.

### DESCRIPTION OF EXAMPLES

In order to illustrate the apparatus and methods according to the invention we now describe a number of examples.

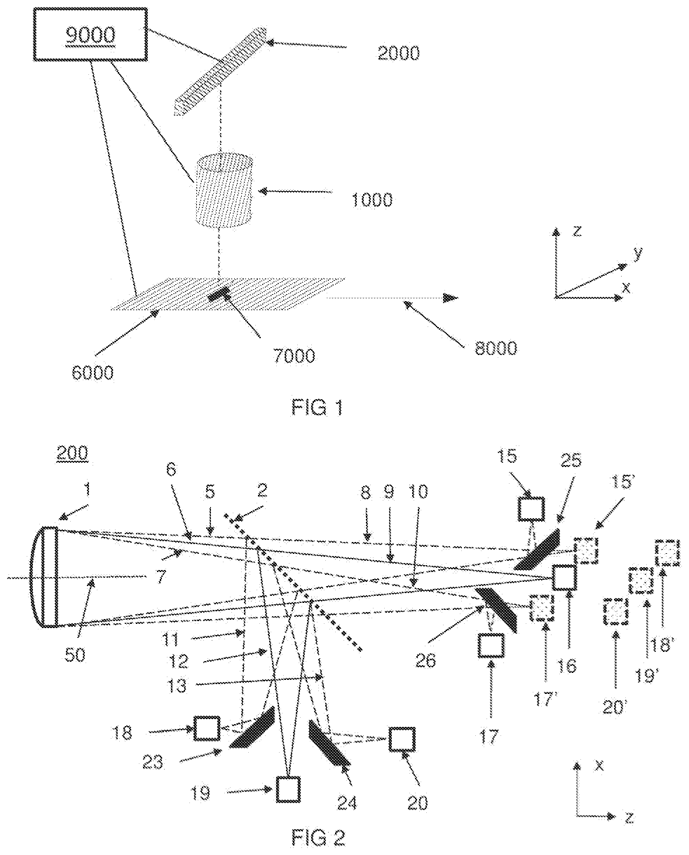

Firstly with reference to FIG. 1 there is illustrated a schematic general arrangement of a virtual microscope according to the invention. The arrangement comprises imaging optics 1000 which focus light originating from a microscope slide 6000 onto an imaging sensor 2000. As illustrated, the microscope slide 6000 lies in an x-y plane and the light received at the imaging sensor 2000 travels generally in a direction z which is normal to the x-y plane. It should be appreciated however that the direction z does not need to be normal to the x-y plane.

The imaging optics 1000 and the imaging sensor 2000 together make up an imaging system. As the imaging sensor 2000 is a line scan detector, the image area 7000 on the relevant part of the microscope slide is a line. In order to produce an extended image over a larger area of the slide 6000, the slide is moved relative to the imaging lens and line scan detector, as indicated by arrow 8000. In this sense the slide is “scanned” by the line scan detector and the resultant data obtained is processed to form an image. The apparatus is operated by a control system 9000 which includes a computer for controlling each aspect of the operation of the microscope, together with providing a user interface and image processing functionality.

The imaging sensor 2000 is typically used to image a sample prepared upon the slide. The sample may be a biological specimen for example. Typically, the sample to be imaged will have an inhomogeneous surface topography with a focus variation greater than the depth of field of the imaging system. A single scan of the slide may be approximately 1 mm wide and between 2 mm and 60 mm long. Over the scale of 1 mm, the focus of the sample very rarely exceeds the depth of focus of the imaging system (typically approximately 1 μm). However, over larger distances such as 20 mm, the change of focus of the sample can exceed the depth of field of the imaging system. For this reason a plurality of imaging sensors are provided, arranged at different focus levels. A focus level can be thought of as being analogous to that of a position in space such that the nominal in-focus level is the position of the focal plane of the image scanning apparatus. Thus providing imaging sensors located at different focus levels in the apparatus allows the imaging of different planes within the target which have plane normals parallel to the optical axis.

A first example is shown in FIG. 2 in which an apparatus 200 is provided. A focusing system 1, analogous to the imaging optics 1000 of FIG. 1, is schematically illustrated to the left hand side of the drawing. This receives light from a target sample (not shown) which may be positioned upon a microscope slide for example and illuminated using a number of different techniques. Typically these are transmissive or reflective broad band illumination techniques such as bright field, dark field, phase contrast and fluorescent illumination. The non-polarising examples discussed herein would also work with polarising illumination.

The focusing system 1 converges light originating at different positions within the target towards a first beam splitter 2. The first beam splitter, and indeed other beam splitters described herein, may take a number of known forms, such as a cube formed from two triangular prisms made of glass, or a half-silvered mirror. In the present case the beam splitter 2 is arranged to reflect 50% of the light through an angle of 90 degrees whilst allowing the remaining 50% to be transmitted through the beam splitter and generally along the optical axis 50 of the focusing system 1.

In FIG. 2 three different locations provide the originating light which passes through the focusing system 1. These locations are spaced laterally with respect to each other on the target, with one being intersected by the optical axis 50 of the focusing system 1. In FIG. 2, a position on the target to a first side (along the x dimension) of the optical axis 50 originates the converging dashed rays 5. A position to the opposing side of the optical axis 50 originates the converging dashed rays 7 and the on-axis position which is intersected by the optical axis 50 originates the converging solid rays 6. Interaction with the beam splitter divides these rays 5,6,7 into transmitted rays 8,9,10 and reflected rays 11,12,13 respectively. A first imaging sensor 16 is positioned on the optical axis 50 at a first focus level given by a first dimension along the z axis (illustrated in FIG. 2). A mirror 25 is used to reflect the ray 8 towards a second imaging sensor 15 which is provided at an effective position indicated at 15′. Likewise, a second mirror 26 is used to reflect the ray 10 towards a third imaging sensor 17 which is provided at an effective position indicated at 17′. A similar arrangement is used for the reflected rays 11,12,13 with respective imaging sensors 18,19,20 and mirrors 23,24 for the imaging sensors 18,20. The imaging sensors 18,19,20 have effective positions shown at 18′,19′,20. Each of the positions 15′,16,17′,18′,19′,20′ has a different respective focus level. In this case the focus levels for the reflected rays 11,12,13 have a larger dimension along the z axis than the transmitted rays 8,9,10. As will be understood, the mirrors 23,24,25,26 are convenient to allow greater spacing between the imaging sensors.

In the present case each of the imaging sensors is a line scan detector although in this particular example time a delay integration (TDI) sensor could be used as an alternative. When the microscope slide containing the target (image areas 7000) is translated with respect to the imaging optics 1000 and focusing system 1, image data is recorded at each of the focus levels corresponding to the effective image sensor positions 15′,16,17′,18′,19′,20′. The image data may be used to construct an image at each focus level with respect to the dimension z so that a Z stack of 6 images at different focus levels is generated.

Due to the different positions with respect to the optical axis 50 from which the light rays 5,6,7 originate, in this example, without the beam splitter, there would be no loss of light to each imaging sensor 15,16,17. The three imaging sensors give a three Z stack simultaneously. It is possible to increase the number of sensors to produce additional Z stacks with the use of additional mirrors or to use a single beam splitter with the loss of 50% of light to each imaging sensor. In this way six imaging sensors produce a six Z stack simultaneously with the loss of only 50% of the light to each imaging sensor.

This provides an advantage over systems with fewer, or even a single, imaging sensor since it may obviate the need for repeated scanning of the same area of the target for example by either the reverse of the scanning system at the end of each pass at a given focus level, or the rewind of the scanning system to the same start position. With a rapid scanning system this extra movement can occupy a high proportion of the scanning time. Whilst FIGS. 1 and 2 show a flat Z stack scan, similar benefits are derived if the Z stack is arranged to follow the nominal surface of the tissue or cells of the target. These approaches may be used with each of the examples described here.

As described above, the first example scans a six Z stack by using 6 separate sensors, each arranged to be at different focus levels which can be thought of as focal planes.

A different approach is to construct a scanner that is also able to scan a 6 Z stack in one pass with only three sensors. This still eliminates the end of stack turn around time but reduces the number of sensors required by a factor of two. Imaging sensors are expensive devices and to reduce the sensor number is advantageous not only in terms of the reduction in the number of sensors but also in terms of reducing support peripherals and potentially providing a more compact apparatus as a whole. A number of examples are now discussed which use this different approach.

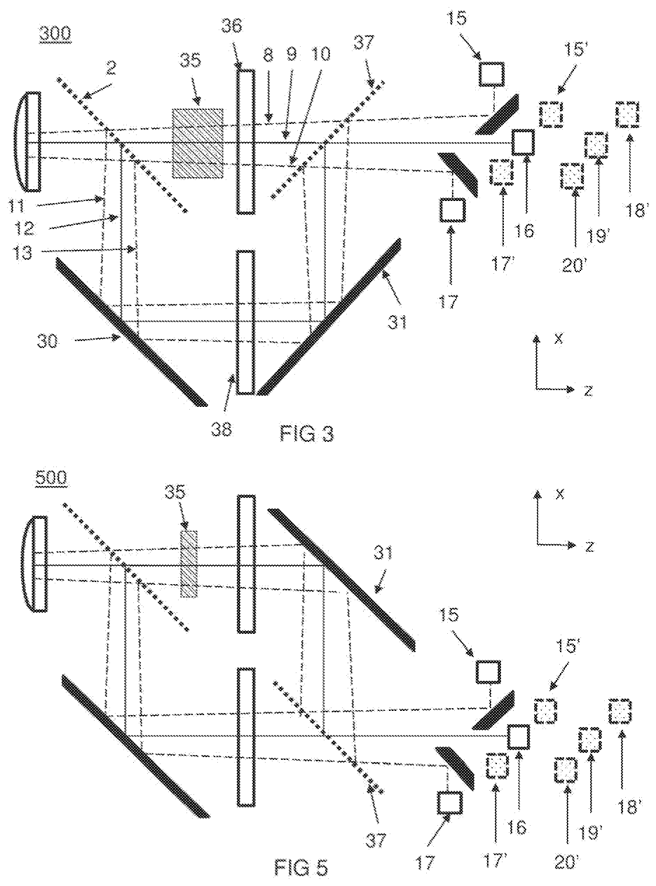

Referring to FIG. 3, in this second example, apparatus 300 has two different optical paths which are provided between the focusing system 1 and the imaging sensors 15,16,17. Unlike in FIG. 2, here only principal rays, rather than marginal rays, are drawn in the interests of clarity. In this example a second beam splitter is used to recombine the two paths prior to the light being incident upon the imaging sensors. When in use, the transmission of the light is switched alternately between the two optical paths. One optical path is slightly longer than the other, which is used to provide the additional focus levels needed when the number of imaging sensors has been halved.

In FIG. 3, the three rays 8,9,10 which are transmitted by the beam splitter 2 travel generally parallel to the optical axis 50 and pass through a glass block 35 which is designed to optically lengthen the path of the light rays to approximately match that of the light which is reflected by the beam splitter 2. The “retarded” light rays then pass through a first optical shutter 36 before being incident on a second beam splitter 37. The second beam splitter is angled at 45 degrees to the optical axis 50 and transmits 50% of the rays in the first light path. The rays which pass through the second beam splitter 37 are incident upon the imaging sensors 15,16,17. Thus the rays 8,9,10 travel on a first light path between the focusing system 1 and the imaging sensors 15,16,17.

Returning to the first beam splitter 2 in FIG. 3 the three rays 11,12,13 which are reflected by the beam splitter 2 (in a downward “−x” direction in FIG. 3) are reflected firstly off a mirror 30 which is angled to divert the light path through 90 degrees. The rays then pass through a second optical shutter 38 and are then reflected by a second mirror 31 which is also angled to divert the light path through 90 degrees. The rays then travel upwards in FIG. 3 (+x) and are then incident upon the second beam splitter 37 which transmits 50% of the light through it and reflects 50% through a final 90 degree angle (in the +z direction, to the right in FIG. 3) so as to direct it on to the three imaging sensors 15,16,17. The rays 11,12,13 therefore travel on a second light path between the focusing system 1 and the imaging sensors 15,16,17. The glass block 35 compensates for the further physical distance travelled by the light rays in the second light path such that the two effective path lengths only differ by about half of the Z stack dimension in focal distance.

The optical shutters 36 and 38 in this second example are operated in an opposing alternating manner between two modes, a first mode in which light is permitted to be transmitted along the respective light path, and a second where the light is not transmitted along the respective light path. Where the light is not transmitted along the respective light path it may either be absorbed or deflected in a different direction in which it does not ultimately reach the imaging sensors. Put simply, when the first optical shutter 36 is in the transmissive first mode, the second optical shutter 38 is in the non-transmissive second mode and vice versa.

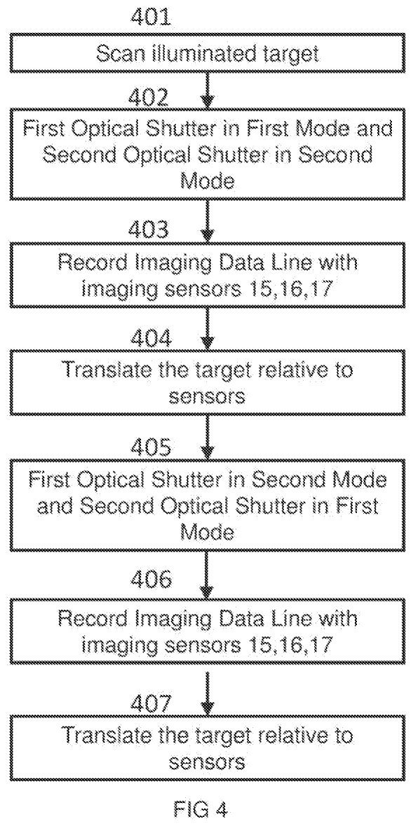

In use, with reference to the flow diagram of FIG. 4, the illuminated target is scanned at step 401. During the scanning motion the first optical shutter 36 is placed in the first mode (transmissive) and the second optical shutter 38 is placed in the second mode (non-transmissive) at step 402. The only light reaching the imaging sensors is therefore being transmitted along the first light path. At step 403 the image data is recorded for each of the imaging sensors 15,16,17 which in practice comprises a line of pixel data for each sensor. The translation of the scanning system continues at step 404 and the optical shutters 36,38 are switched at step 405 into their opposite modes such that the light reaching the sensors then travels along the second light path via mirrors 30, 31. The image data lines are then recorded at step 406 using the imaging sensors 15,16,17 and the translation of the target then continues at step 407. The method continues by looping back to step 402 with steps 402 to 407 being repeated numerous times to build up interleaved image data for the target. The data are then processed after all the desired data has been acquired so as to extract two different images with two different focus levels. Each sensor will collect a line interleaved image of two focus levels. One from each path. For example the path at step 403 will be on the odd numbered lines and the path at step 406 will be on the even lines. If a camera is used to capture the image then this deinterleaving of the lines is required to obtain each of the two different focus images. Specialised electronics could do this on the fly but even with such specialised electronics it is normal to cluster lines of an image into buffers rather than transfer a line at a time. This deinterleaving will still occur on a multiline buffer as well so even specialised electronics uses a deinterleave process.

The apparatus 500 as shown in FIG. 5 uses similar principles as that of the apparatus 300. In the present case the first and second path lengths are made of more similar length by ensuring that each ray has to be reflected twice prior to arriving at the imaging sensors 15,16,17. This is achieved by effectively swapping the positions of the mirror 31 and second beam splitter 37, together with relocating the imaging sensors 15,16,17. Thus, as it shown, it is not required to have a “straight through” optical path that follows the optical axis 50. The benefit of this arrangement is that it enables the glass block 35 to have a smaller thickness that is only required to produce the focus differences between two optical paths rather than compensating for differing lengths of the optical paths as well.

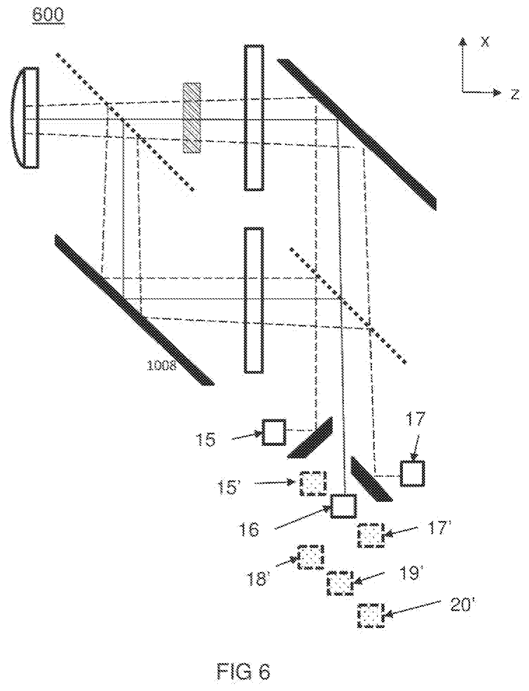

There are two options for the positioning of the imaging sensors 15,16,17. The first, as is illustrated in FIG. 5, preserves the relative arrangement of the imaging sensors with respect to each other and translates the arrangement (in a direction, −x, downward in the figure). The second is illustrated in FIG. 6 where the only difference between the two apparatus is the positioning of the imaging sensors 15, 16, 17. In FIG. 6 with the apparatus 600, the arrangement of the imaging sensors of the apparatus 500 is rotated 90 degrees about an axis y normal to the figure, rotated 180 degrees about the x axis lying in the vertical direction in the plane of the figure and displaced along x such that the imaging sensors 15,16,17 receive light travelling in a downward, −x, direction in FIG. 6.

The switching between optical paths can be performed by devices such as MEMs mirrors, liquid crystal shutters or Photo Elastic Modulators, Pockels cells or rotating shutter wheels.

The embodiments described above will lose at least 75% of the light due to the use of two beam splitters and modulators since most of the modulators mentioned will cause some additional light loss.

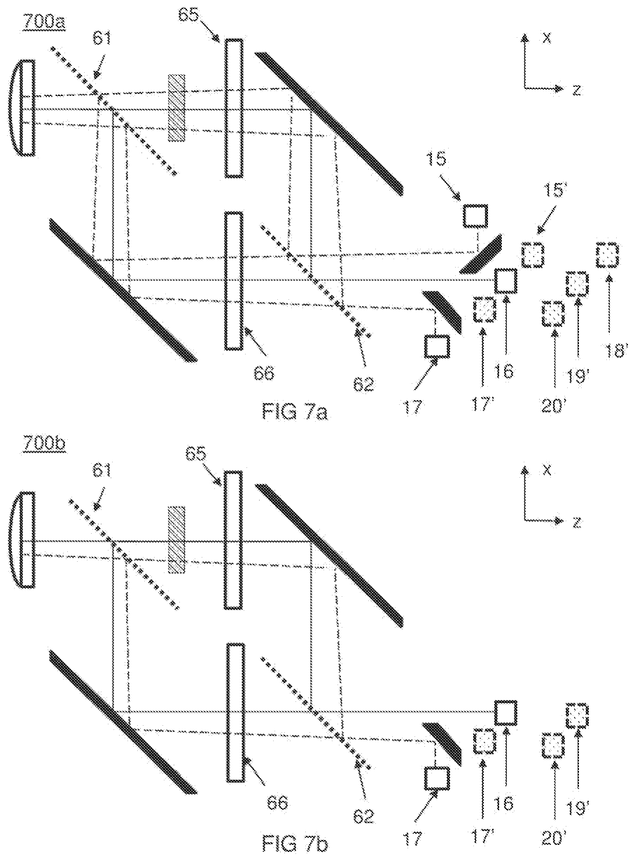

A further example which reduces the loss of light is provided by the apparatus 700 shown in FIG. 7a. This has a similar arrangement to that of apparatus 500 and replaces the beam splitters 2, 37 with polarising beam splitters 61, 62. There is still a 50% loss of intensity for each optical path due to the separation by polarising beam splitter 61 into s and p beams. The combination of beams into a single beam by polarising beam splitter 62 does not reduce the light level received at the imaging sensors 15,16,17. This means there is only a 50% reduction in light intensity, which rivals the performance of the apparatus 200 of FIG. 2 but with only three imaging sensors. The apparatus illustrated in FIG. 7b is the same as that in FIG. 7a, although in this latter case only uses two imaging sensors (with imaging sensor 15 being removed) and therefore produces a Z stack of 4 images.

In addition, if a Photo Elastic Modulator (PEM) or Pockels cell is used to implement the optical shutters 65,66 then minimal further light loss is achieved due to the alignment of the polarisation states of the respective light rays received and the plane of polarisation of the optical shutters. Typically a polariser loses more than 50% of the light. A commercial modulator will normally include a second polariser which is not beneficial here since the beam has already been polarised with beam splitter 61. This second polariser will therefore cause an unnecessary loss of light. A PEM obviates the second unrequired polariser. In effect the two beam splitters 61 and 62 become part of the modulator device when combined with something that only rotates polarisation and as such the losses are reduced.

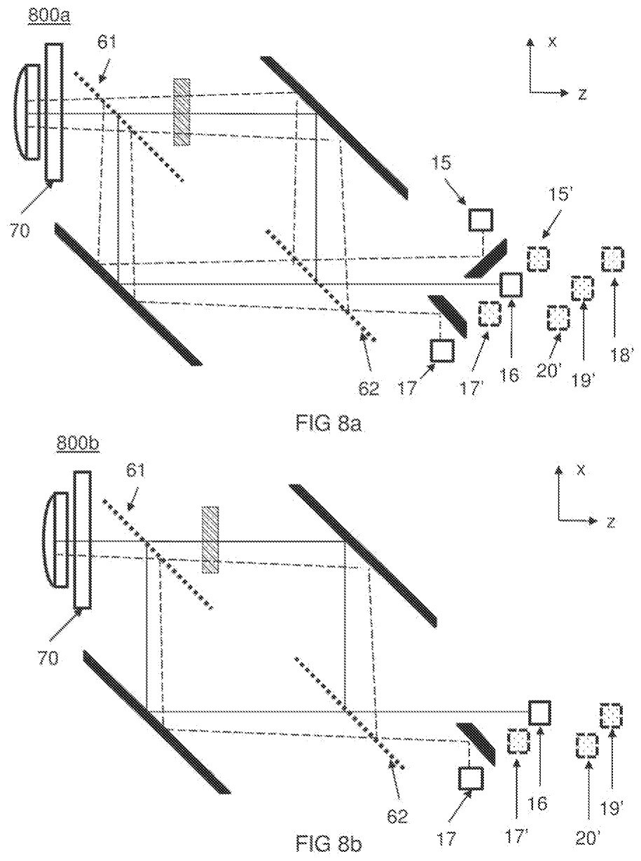

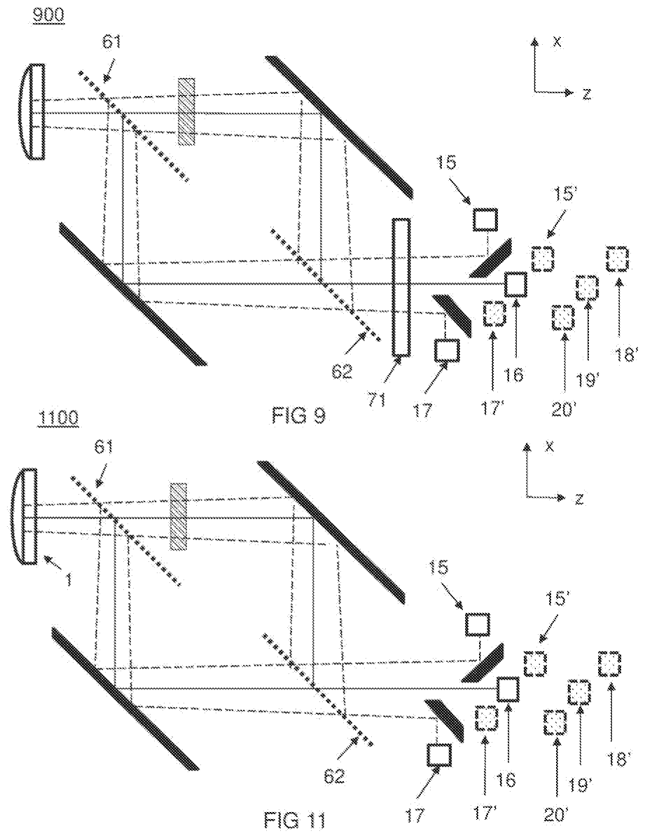

In further examples the requirement for the two optical shutters 65,66 can be replaced with a single optical shutter by placing the PEM with an analyser in the light path either upstream or downstream of the region where the two optical paths are separated spatially. The polarising optical shutters have somewhat different function in comparison with the earlier examples in that in this case they provide two modes and in each mode the light is transmitted down a respective light path (which may be overlapping in part). This is shown by 70 in the apparatus 800 of FIGS. 8 and 71 in the apparatus 900 of FIG. 9. Again, the apparatus in FIG. 8a is provided with three imaging sensors, whereas that in FIG. 8b has two imaging sensors. In each case the PEMs can select which optical path transmits the received light through to the imaging sensors.

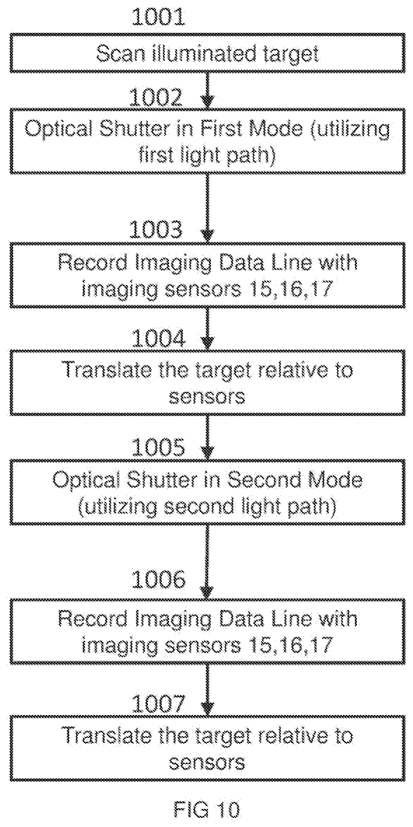

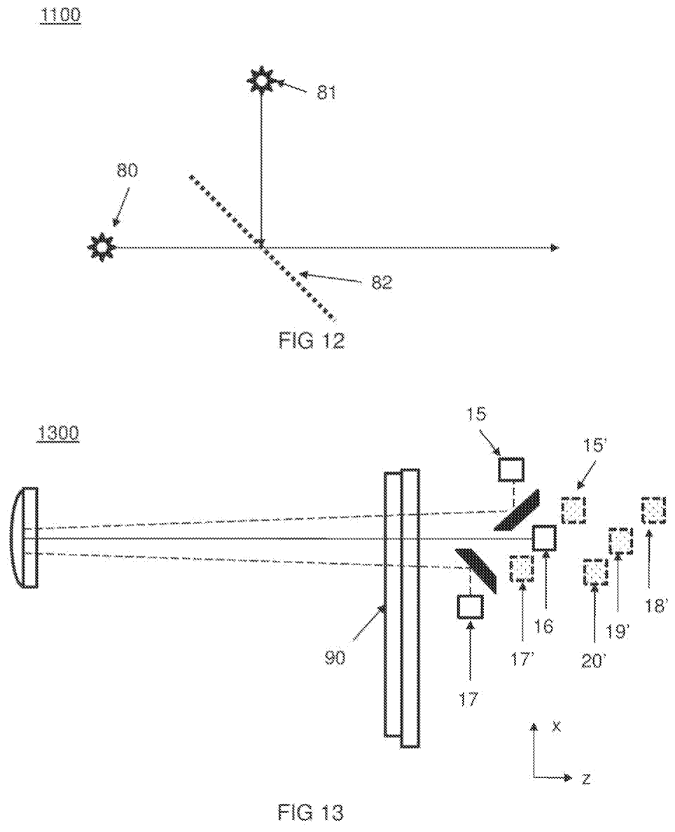

The flow diagram of FIG. 10 illustrates the operation of the apparatus 800,900. The illuminated target is scanned at step 1001. During the scanning motion at step 1002 the optical shutter 70,71 is placed in the first mode such the only light transmitted along the first path (upper part of the respective figures) reaches the imaging sensors 15,16,17. At step 1003 the image data is recorded for each of the imaging sensors 15,16,17. The translation of the scanning system continues at step 1004 and the optical shutter 70,71 is switched at step 1005 into the second mode such that the light reaching the imaging sensors 15,16,17 is only that which has travelled along the second light (lower part of the respective figures). The image data lines are then recorded at step 1006 using the imaging sensors and the translation of the target then continues at step 1007. The method continues by looping back to step 1002 with steps 1002 to 1007 being repeated numerous times to build up interleaved image data for the target. The data are then processed once all the desired data has been acquired so as to extract two different images with two different focus levels.

In another example the polarising optical shutters can be removed as illustrated in the apparatus 1100 of FIG. 11. In this case the optical shutter takes the form of the light source of the scanner which may be modulated by using two separate light sources 80,81 which are combined into one optical path with a polarising beam splitter 82. If an LED light source is used for each of the sources 81,82 it is possible to alternate the modulation of the LEDs to produce different polarised light from line to line in the image and the modulation will select which optical path will be used. The light received from through the focusing system 1 in FIG. 11 is therefore polarised in two different planes depending upon the light source from which it originated. During the operation of the apparatus 1100 as described in FIG. 10, the first mode relates to the operation of light source 60 only, and the second mode to the operation of light source 61 only.

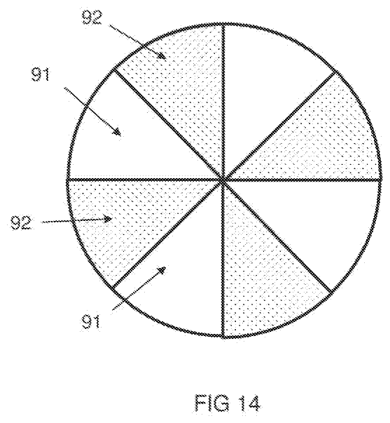

A final example 1300 shown in FIG. 13 uses a beam splitter in the sense of a device which produces two light paths which physically follow the same geometry, at different times, but have different optical path length due to the use of two different transmission media. This allows the production of two optical paths of different lengths and enables the imaging sensors 15,16,17 to be used to produce 6 different focus levels. If three different material optical thicknesses were used then nine focus levels would result, and so on. This is achieved using a rotating wheel 90 with material of different optical thicknesses spaced azimuthally about its central axis. The different optical thicknesses may be achieved by a different index of refraction or physical thickness, or each of these.

As is illustrated in FIG. 14, the wheel 90, when rotating, presents alternating regions with optical thicknesses of transparent material 91,92 to an incident beam and is rotated to switch different optical path lengths into the beam of each line of the image. In this example there is no loss of light, but the beam splitting function is temporal and so time must be permitted for the transition of regions (in this case segments) of the wheel to transit the optical path before imaging occurs to prevent each line being a blend of focus levels. This may be achieved by reduced integration time which is has the property to reducing the quantity of light on the sensor.

1. Image scanning apparatus comprising:
a plurality of imaging sensors for generating image data;
a focusing system defining an optical axis and adapted in use to direct light received from a target on to the plurality of imaging sensors;
wherein each imaging sensor is positioned with respect to the focusing system such that, the light directed to the imaging sensor has an optical focus level with respect to the target which is different from each other imaging sensor, and the light is received from a position on the target with respect to the optical axis which is different from the respective position for each other imaging sensor;
wherein the focusing system comprises an optical path modifier adapted to generate a first light path between the optical path modifier and at least one of the plurality of imaging sensors, and a second light path between the optical path modifier and at least one of the imaging sensors, wherein the first light path is different from the second light path; and
a scanning system arranged in use to cause the target to be moved relative to the optical axis such that an image of the target may be generated using the image data from the plurality of image sensors;
wherein the apparatus further comprises a switching mechanism configured to be switched a first mode in which the light is transmitted along the respective light path and a second mode in which the light is not transmitted along the respective light path.

2. Image scanning apparatus according to claim 1 wherein in the first mode the light is transmitted along the first optical path and not the second optical path, and in the second mode the light is transmitted along second optical path and not the first optical path.

3. Image scanning apparatus according to claim 1, wherein the optical path length of the first light path is different from the optical path length of the second light path.

4. Image scanning apparatus according to claim 3, wherein the combination of the specific position upon the target and the specific light path results in a focus level which is different from each other focus level.

5. Image scanning apparatus according to claim 3, further comprising a retarding element placed in the one of the said first or second light paths, the retarding element having a refractive index arranged to modify the optical path length of the said optical path in which it is placed.

6. Image scanning apparatus according to claim 3, wherein the optical path modifier is a first beam splitter and wherein the apparatus further comprises a second beam splitter arranged to combine the first and second light paths back together.

7. Image scanning apparatus according to claim 6, wherein the imaging sensors are arranged to receive light from each of the first and the second light paths and wherein the switching mechanism comprises:
a first optical shutter in the first light path; and
a second optical shutter in the second light path,
wherein each of the first and second optical shutters is adapted to be switched between the first mode and the second mode.

8. Image scanning apparatus according to claim 7, wherein a part of the second light path between the first and second beam splitters comprises the second optical shutter and at least one mirror.

9. Image scanning apparatus according to claim 6, wherein the imaging sensors are arranged to receive light from each of the first and the second light paths, wherein each beam splitter is a polarising beam splitter, and wherein the switching mechanism comprises a polarising optical shutter adapted to be switched between the first mode and the second mode.

10. Image scanning apparatus according to claim 9, wherein the polarising optical shutter is placed upstream of the first polarising beam splitter or downstream of the second polarising beam splitter.

11. Image scanning apparatus according to claim 10, wherein when the polarising optical shutter is upstream, the polarising optical shutter comprises a polarising beam splitter, a first light source having light arranged to be transmitted through the polarising beam splitter in an illumination direction and a second light source having light arranged to be reflected by the polarising beam splitter in the illumination direction and wherein the light from the first light source travelling in the illumination direction is arranged to have a different polarisation plane than the light travelling in the illumination direction from the second light source.

12. Image scanning apparatus according to claim 7, wherein the respective first optical shutter, second optical shutter or polarising optical shutter is selected from the group comprising: a rotatable slotted disc, a photoelastic modulator (PEM), a Pockels cell, a micro-electromechanical system (MEMs) mirror, a liquid crystal shutter or a mechanical shutter.

13. Image scanning apparatus according to claim 1, wherein the switching mechanism comprises an optical shutter and the switching mechanism forms part of the optical path modifier.

14. Image scanning apparatus according to claim 13, wherein the optical path modifier is provided as a rotating disc having a plurality of regions positioned about its axis, the regions being of two or more different optical thicknesses and arranged azimuthally according to an alternating pattern of thicknesses.

15. Image scanning apparatus according to claim 1, wherein the focusing system forms at least part of a microscope.

16. Image scanning apparatus according to claim 1, wherein the image is a Z stack image in which each position of the target is imaged at different focus levels.

17. Image scanning apparatus according to claim 16, wherein the image is a Z-stack having four levels generated using either two or four imaging sensors, or wherein the image is a Z-stack having six levels generated using either three or six imaging sensors.

18. A method of image scanning using image scanning apparatus according to claim 7, the method comprising:
operating the first optical shutter and the second optical shutter such that the first optical shutter is in the first mode when the second optical shutter is in the second mode and the first optical shutter is in the second mode when the second optical shutter is in the first mode, so as to selectively transmit the light along the first light path and the second light path.

19. A method of image scanning using image scanning apparatus according to claim 9, the method comprising:
operating the polarising optical shutter so as to selectively transmit the light to the imaging sensors, along the first light path and the second light path or operating the polarising optical shutter in its respective first and second modes, alternately, whilst the target is moved relative to the optical axis so as to generate image data at a plurality of focus levels.

20. A method according to claim 18, wherein the first optical shutter and second optical shutter are operated in their respective first and second modes.
